(19) United States
(12) Patent Application Publication
(10) Pub. No.: US 2007/0219904 A1
(43) Pub. Date: Sep. 20, 2007

(54) System and method for electronic processing of payment obligations

(76) Inventors: David P. Kurrasch, Alameda, CA (US); David F. Kvederis, Moraga, CA (US)

Correspondence Address: FISH & RICHARDSON P.C., P.O. BOX 1022, MINNEAPOLIS, MN, 55440-1022, US

(21) Appl. No.: 11/376,515

(22) Filed: Mar. 15, 2006

(51) Int. Cl. G06Q 40/00

(52) U.S. Cl. 705/40

(57) ABSTRACT

Methods for processing data related to obligations to pay (“OP”) (e.g., checks) in connection with an electronic accounting system (“AS”) are disclosed. In an embodiment of one method, data for one or more OPs (e.g., scanned images of the paper checks) is received. For each of the OPs: it is determined whether the OP matches any accounts requiring payment (“ARPs”) at the AS for which an OP was previously posted. If so, a list of matching ARPs is presented to the user and the user selects one of the listed ARPs. The AS is instructed to post the OP to the selected ARP. If there are no matches, the user posts the OP to one of the ARPs at the AS. The amounts of all the OPs are accumulated and credited to an account tracking cash at the AS. Data for the OPs is sent to financial institutions for clearance.

### FIELD OF THE INVENTION

The present invention relates to the field of processing obligations to pay (“OP”) made by one party to another (e.g., checks and electronic funds transfers), and in particular, to processing such obligations electronically in connection with a computerized accounting system.

### BACKGROUND OF THE INVENTION

Banking and other financial institutions have long enabled customers to write paper checks, originate electronic entries and similar instruments to draw cash from their accounts and tender payments to third parties. The widespread use of paper checks necessitated the development of methods by which to handle, process, and transport large quantities of checks by businesses that accepted such instruments as payment. Traditionally, payees would receive paper checks, manually apply funds to open accounts receivable, reconcile the receivables to cash received, prepare bank deposits, and manually transport checks to a bank for credit, clearance, and value.

The traditional methods of handling and processing paper checks are prone to human error, costly, and slow. In particular, the traditional manual method of applying funds to and reconciling accounts receivable are laborious and error prone. Delays and errors in paper check processing often result in reduced customer satisfaction and increased customer service concerns. More seriously, such delay and error can potentially cause or exacerbate accounting, regulatory, tax, and shareholder value concerns.

Advances in computer imaging have now made it possible to create high resolution digital facsimiles of paper checks. The use of electronic check images has many advantages over the use of conventional paper checks. In particular, processing and handling of electronic check images is faster, more efficient, less costly, and less error prone than the processing and handling of paper checks. Recognizing these advantages, the U.S. Congress recently enacted legislation, known as the Check Clearing for the 21^{st} Century Act (“Check 21 Act”) to foster the development of electronic checking systems. That legislation authorized the use of electronic check images as proxies for original paper checks and set standards to be used by all financial service providers.

### SUMMARY OF THE INVENTION

Embodiments of the invention simplify the application of obligations to pay (“OPs”) that are in paper form (e.g., checks) to electronic accounting systems by converting the OPs to electronic data and helping a user identify the correct account(s) requiring payment to which to post the OPs. Account requiring payment, as used herein, refers to any account for which payment is expected including, for example, an account receivable or any other obligation, such as a loan. Embodiments of the invention also simplify the process of generating cash entries to an account in which cash is tracked (e.g., a general ledger) and sending images of OPs for delivery and clearance through the banking system.

In an embodiment of the invention, a method for facilitating the operation of an electronic accounting system is provided. First, data describing an obligation to pay is received. Then, the received data is compared with data stored in one or more records, wherein each of the one or more records stores data describing a previously received obligation to pay and one of one or more accounts requiring payment at an electronic accounting system to which the previously received obligation to pay was posted. Next, each of the one or more records whose description of a previously received obligation to pay that matches the received data are identified. Then, a selection of one of the identified records is received from a user. Finally, the method involves causing the electronic accounting system to post the obligation to pay described by the received data to the account requiring payment described in the selected record.

According to a different embodiment of the invention, if there are no identified records, the method involves receiving from a user a selection of one of the one or more accounts requiring payment at the electronic accounting system, adding a record to the one or more records, the added record storing the received data and data describing the selected account requiring payment, and causing the electronic accounting system to post the obligation to pay described by the received data to the selected account requiring payment.

In another embodiment of the invention, the received data includes an amount to be paid, the electronic accounting system has an account in which cash is tracked, and the method further involves causing the electronic accounting system to credit the amount described by the received data to the account in which cash is tracked.

According to other embodiments of the invention, the obligations to pay described by the received data and the data stored in each of the one or more records includes one or more checks or one or more electronic funds transfers.

In another embodiment of the invention, a method is provided for facilitating the operation of an electronic accounting system having an account in which cash is tracked. The method involves receiving data describing an obligation to pay being returned, including an amount, identifying an account requiring payment at the electronic accounting system corresponding to the obligation to pay being returned, and causing the electronic accounting system to subtract the amount of the obligation to pay being returned from the identified account requiring payment and from the account in which cash is tracked.

In a different embodiment of the invention, another method is provided for facilitating the operation of an electronic accounting system having an account in which cash is tracked. The method involves (1) receiving data describing a plurality of obligations to pay, the data including an amount to be paid for each of the plurality of obligations to pay, and (2) for each of the plurality of obligations to pay described by the received data, processing a portion of the received data describing the respective obligation to pay by: (a) comparing the portion of the received data describing the respective obligation to pay with data stored in one or more records, wherein each of the one or more records stores data describing a previously received obligation to pay and one of one or more accounts requiring payment at the electronic accounting system to which the previously received obligation to pay was posted, (b) identifying each of the one or more records whose description of a previously received obligation to pay matches the portion of the received data describing the respective obligation to pay, (c) receiving from a user a selection of one of the identified records, and (d) causing the electronic accounting system to post the respective obligation to pay to the account requiring payment described in the selected record, (e) if there are no identified records: (i) receiving from a user a selection of one of the one or more accounts requiring payment at the electronic accounting system, (ii) adding a record to the one or more records, the added record storing the portion of the received data describing the respective obligation to pay and data describing the selected account requiring payment, (iii) causing the electronic accounting system to post the respective obligation to pay to the selected account requiring payment, (f) accumulating the amount of the respective obligation to pay with the amount of any obligation to pay of the plurality of obligations to pay whose data has been previously processed, and (3) causing the electronic accounting system to credit the amount accumulated from all the obligations to pay of the plurality of obligations to pay to the account in which cash is tracked.

Additional aspects of the present invention will be apparent in view of the description which follows.

### DESCRIPTION OF DRAWINGS

The invention is illustrated in the figures of the accompanying drawings, which are meant to be exemplary and not limiting, and in which like references are intended to refer to like or corresponding parts.

FIG. 1 is a block diagram of an embodiment of the system of the present invention showing the environment in which the system operates;

FIG. 2 shows several example records of a database that may be used in the present invention;

FIG. 3 is a flow chart showing an operative embodiment of the present invention; and

FIG. 4 is a flow chart showing another operative embodiment of the present invention.

Like reference symbols in the various drawings indicate like elements.

### DETAILED DESCRIPTION

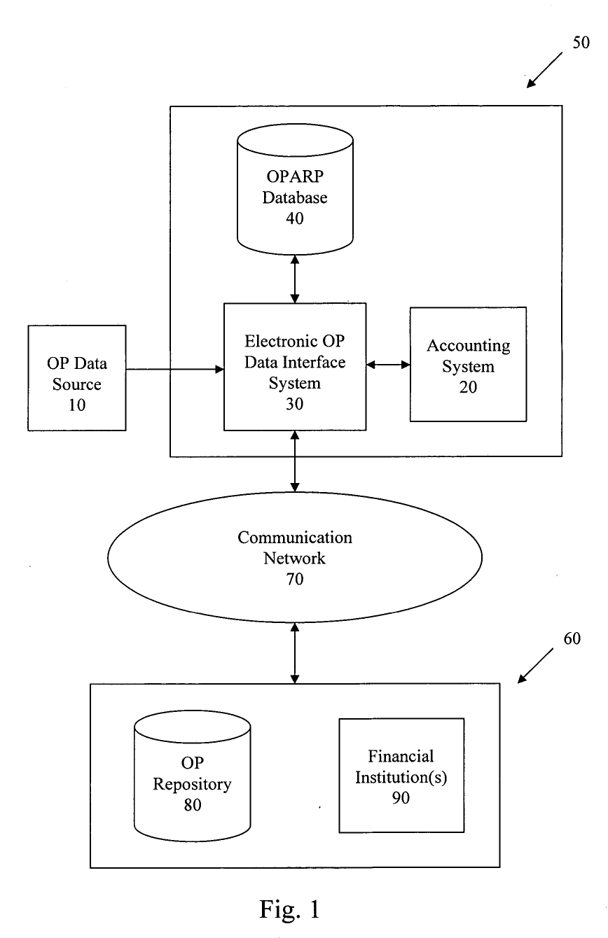

FIG. 1 presents a diagram showing an embodiment of the Electronic Obligation to Pay Data Interface (“EOPDI”) System and the environment in which it operates. According to the embodiment shown in FIG. 1, the EOPDI System 30 is in communication with an obligation to pay (“OP”) data source 10, an electronic accounting system 20 and a database 40. EOPDI System 30 is also in communication with OP clearance system 60 via communication network 70.

Obligation to pay (“OP”), as used herein, refers to any obligation of one party to make a payment to another party, including, for example, a promissory note, a check, or an electronic funds transfer. Obligation to pay (“OP”) data source 10 may comprise any apparatus or system capable of providing electronic data related to obligations to pay. This data may include, for instance, an electronic image of a check or data from a check that can be used to produce an electronic funds transfer (“EFT”), such as, for example, some or all of the following: an Accounts Receivable Conversion standard entry class code transaction that qualifies under the rules of the National Automated Clearinghouse Association, the ABA Routing & Transit Number of the payor's bank and the payor's specific checking account, the check serial number and the dollar amount of the check. According to an embodiment of the invention, OP data source 10 comprises a computer peripheral device, such as a check scanner, capable of capturing data related to an OP (e.g., an electronic image of a check captured using known scanning technology and/or data that can be used for an EFT captured using either magnetic ink character recognition (“MICR”) or optical character recognition (“OCR”)) and transmitting the data related to the OP over a physical or wireless data communication link (e.g., USB cable or Bluetooth link). If desired, the check scanner may be designed so as to produce a check image that meets all the requirements of the Check 21 Act.

Accounting system 20 may comprise any computing system that enables a user to keep track of OPs. Computing system, as used herein, refers to computer hardware and software or computer software only. For example, in an embodiment of the invention, accounting system 20 comprises computer software (such as QuickBooks® from Intuit Inc., or, by extension but not limitation, any of the desktop applications from Microsoft Corporation that can be used to account for OPs, such as Microsoft Excel®) being executed by computer hardware 50, which may be, for example, a personal computer.

EOPDI System 20 functions as an interface between accounting system 20 and various entities, such as a user, OP data source 10 and one or more financial institutions 80. As discussed further below, one of the functions of EOPDI System 20 involves assisting users associate received OPs with accounts requiring payment. Account requiring payment (“ARP”), as used herein, refers to any account for which payment is expected including, for example, an account receivable or any other obligation, such as a loan.

EOPDI System 20 may comprise any computing system capable of performing at least the following functions, which are described in detail below: (a) matching data for an OP with an open ARP at accounting system 20; (b) modifying an open ARP at accounting system 20; (c) enabling a user to manually modify an open ARP at accounting system 20; (d) modifying a cash account (e.g., any account used to track cash) at accounting system 20; and (e) transmitting data related to OPs to financial institutions and receiving data related to OPs from financial institutions. For example, in an embodiment of the invention, EOPDI System 20 comprises computer software being executed by computer hardware 50 which causes computer hardware 50 to perform these functions. For instance, where EOPDI System 30 may be a software add-on created using a SDK designed to run in conjunction with a particular accounting system (e.g., QuickBooks® or Microsoft Excel®).

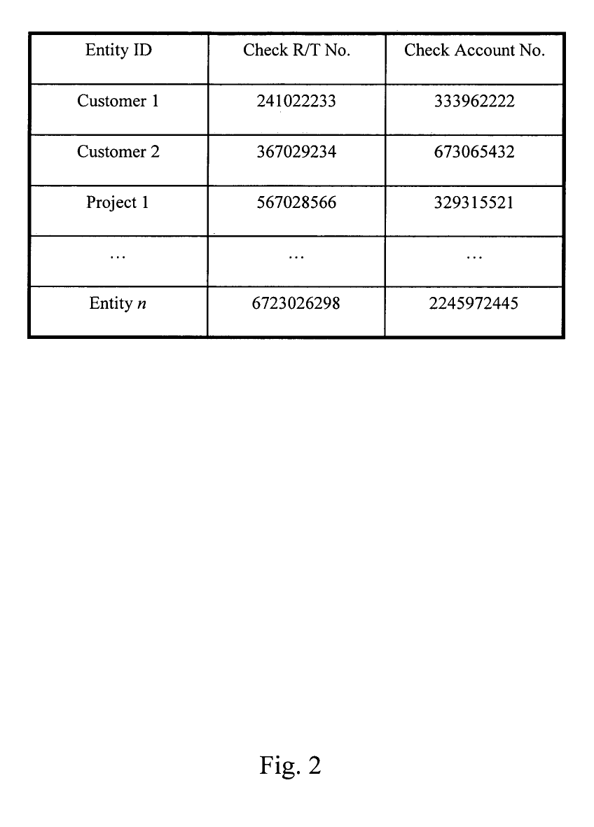

Obligation to pay—accounts requiring payment (“OPARP”) database 40 stores data associating OPs with ARPs at accounting system 20. In accordance with standard accounting procedures, accounting system 20 may maintain an open ARP for each entity (e.g., customer or project) for which OPs are expected to be received. OPARP database 40 may then comprise one or more records each of which stores data associating OPs with a specificARP. FIG. 2 shows a plurality of example records of OPARP database 40 where customers send payment for previously purchased goods or services in the form of checks. As shown in FIG. 2, each record of OPARP database 40 includes (a) the unique entity ID (e.g., customer ID or project ID) of an entity for whom an open ARP exists in accounting system 20 and (b) unique routing and transit (“R/T”) and account numbers for checks corresponding to that entity.

OPARP database 40 may be populated with data during an initialization phase where, for example, a user manually enters customer IDs, check R/T and check account numbers via a graphical user interface provided by EOPDI system 30. In addition, as described below, during operation, when data for an OP is received which does not have a corresponding entity ID, EOPDI system 30 may prompt a user to associate the OP with a specific entity ID at that time.

If desired, OPARP database 40 may also store images of OPs that EOPDI system 30 receives from OP data source 10.

Returning to FIG. 1, the embodiment shown in this figure depicts EOPDI system 30 operating within a single computer hardware environment. In other words, in the embodiment shown in FIG. 1, accounting system 20, EOPDI system 30 and OPARP database 40 are computer software processes that execute and communicate with each other within the same computer hardware 50 and OP data source 10 is an input device (e.g., check scanner) linked to computer hardware 50 so as to be able to provide data to EOPDI system 30. In alternative embodiments, one or more of these components may reside in separate computer hardware located remotely from the other components and be in communication with the other components through known means such as a communication network.

As shown in FIG. 1, EOPDI system 30 is also in communication with OP clearance system 60 via communication network 70. Communication network 70 may comprise any means through which computing systems may communicate with each other, such as wired or wireless LANs, WANs, or the Internet.

OP clearance system 60 comprises the databases and computing systems conventionally known to participate in the clearance of obligations to pay (“OPs”), e.g., checks or electronic funds transfers. For example, OP clearance system 60 includes OP repository 80, which is a central storage of OPs that are in the process of being cleared or have been cleared, and one or more computing systems 90 that are associated with one or more financial institutions which may act as clearing banks or receiving banks for the purpose of clearing OPs.

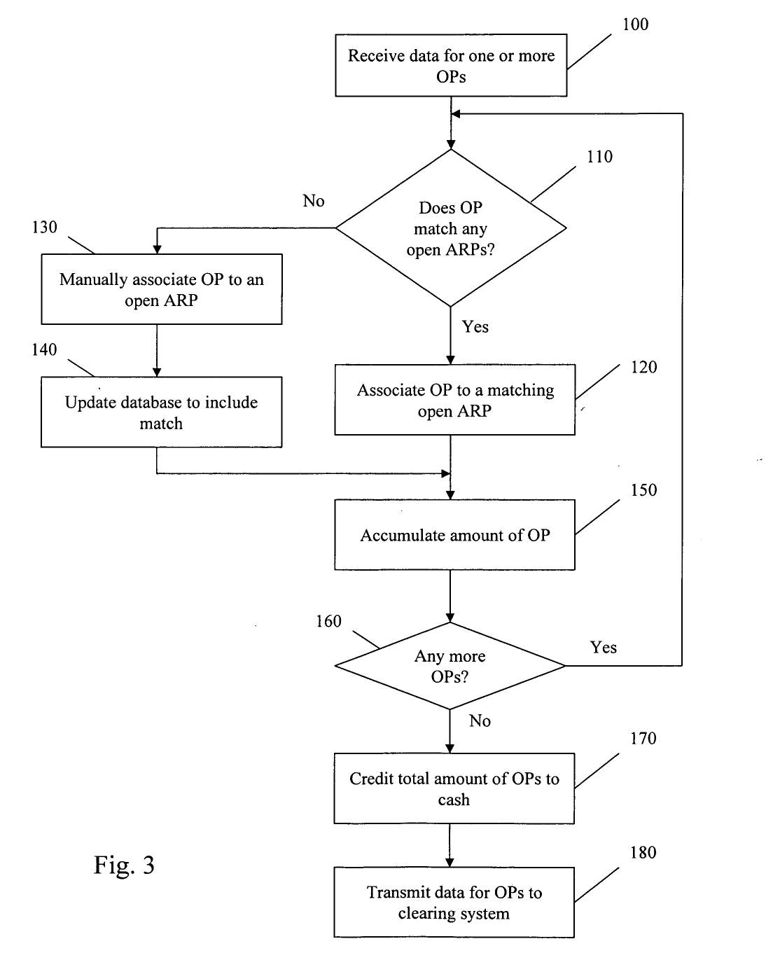

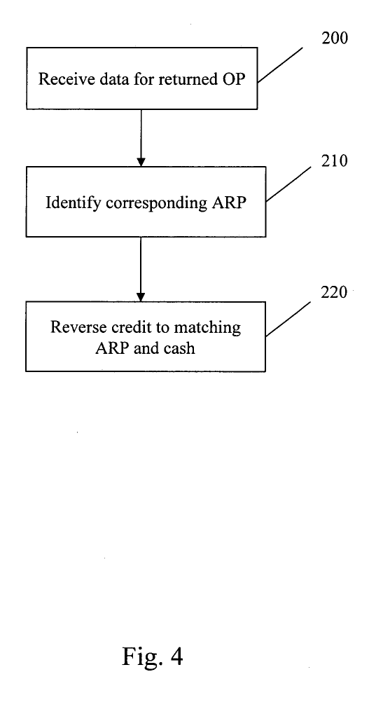

The operation of the EOPDI system of the present invention may now be described in greater detail in connection with the flow charts of FIGS. 3 and 4. FIG. 3 is a flow chart describing an example of how the EOPDI system of the present invention may operate to process OPs received from customers.

First, data for one or more OPs are received, as represented by the operations of block 100. For example, upon receiving one or more checks from customers as payment for goods or services previously purchased on credit, a user operates OP data source 10 (e.g., a check scanner) to convert each check to electronic data which is then sent to EOPDI system 30.

For the first of the one or more OPs received, EOPDI system 30 determines whether the OP matches any open accounts requiring payment (“ARPs”) at accounting system 20, as represented by the operations of block 110. For example, EOPDI system 30 compares the data for the OP (e.g., R/T and account numbers) with the data stored in OPARP database 40 to determine whether there are any matching records (e.g., R/T and account numbers of the OP match the R/T and account numbers of one or more records in the OPAR database).

If the determination represented by the operations of block 110 is positive, then the OP is associated with one of the matching open ARPs, as represented by the operations of block 120. For example, EOPDI system 30 may present a GUI to the user listing all the open ARPs that matched the OP. The user may then operate the GUI to select an appropriate open ARP from the list to which to post the OP. EOPDI system 30 then instructs accounting system 20 to post the OP to the open account receivable selected by the user. Operation of EOPDI system 30 then moves to block 150, discussed below.

If the determination represented by the operations of block 110 is negative, then the OP is manually associated to an open ARP, as represented by the operations of block 130. For example, EOPDI system 30 may query accounting system 20 to obtain information regarding all open ARPS and then present a GUI to the user listing all the open ARPs. The user may then operate the GUI to select an appropriate open ARP from the list to which to post the OP. EOPDI system 30 then instructs accounting system 20 to post the OP to the open ARP selected by the user. EOPDI system 30 then updates OPARP database 40 by adding a record with the entity ID corresponding to the open ARP selected by the user and the R/T and account numbers of the OP just posted so that, in the future, checks with the same R/T and account numbers will be recognized as a match for this ARP.

Following the operations of either block 120 or block 140, the amount of the OP is accumulated, as represented by the operations of block 150. As shown in FIG. 3, the operations of blocks 110, 120, 130, 140, 150 and 160 form a loop that repeats until data for all received OPs has been processed. In the operations of block 150, the amounts of all received OPs are accumulated as the loop repeats. Thus, during the first iteration of the loop, there is no previous amount and so the accumulated amount following block 150 is simply the amount of the OP that was processed. During the second iteration of the loop, the amount of the OP being processed is added to the previous amount, etc.

During the operations of block 150, an electronic deposit ticket may also be created. During each iteration of the loop, data from each OP, such as the serial number and amount of the OP may be accumulated on the electronic deposit ticket.

Following the operations of block 150, EOPDI system 30 determines whether data for any more OPs needs to be processed, as represented by the operations of block 160. If this determination is positive, operation of EOPDI system 30 returns to block 110 discussed above. If this determination is negative, then the total amount of the OPs received is credited to an account tracking cash (e.g., in a general ledger), as represented by the operations of block 170. For example, EOPDI system 30 sends instructions to accounting system 20 to increase the amount of cash in the account at which cash is tracked by the amount accumulated through the successive iterations of the operations of block 150.

Finally, EOPDI system 30 transmits data for all the received OPs to OP clearing system 60, as represented by the operations of block 180. For example, EOPDI system 30 may transmit the electronic image of each received OP to clearing system 60.

The data received by clearing system 60 may be stored in OP repository 80 and passed onto one or more financial institutions 90 (e.g., a clearing bank for delivery to receiving banks) so that the OPs may be further processed (e.g., as electronic funds transfer debits or as electronic check presentations).

As is known, an OP may be returned for any of several reasons, such as insufficient funds, account closed, stop payment or revoked authority. FIG. 4 is a flow chart illustrating an example of how the EOPDI system of the present invention may operate to process returned OPs. First, as represented by the operations of block 200, data for the returned OP is received by EOPDI system 30. For example, in the event of the return of an electronic debit or electronic check presentation, the receiving bank will return entry to the clearing bank which will then transmit information regarding the returned OP (e.g., the image of the check from OP repository 80) to EOPDI system 30, through known techniques.

Next, EOPDI system 30 identifies the account requiring payment (“ARP”) corresponding to the returned OP, as represented by the operations of block 210. For example, from the returned check MICR data, EOPDI system 30 may obtain the R/T and account numbers for the returned check. Then, EOPDI system 30 may search OPARP database 40 to locate a matching record and thereby identify the ARP corresponding to the returned OP.

Finally, EOPDI system 30 reverses the amounts previously credited in connection with the returned OP, as represented by the operations of block 220. For example, EOPDI system 30 may instruct accounting system 20 to subtract the amount of the returned OP (e.g., as indicated in the information received by EOPDI system 30) from the credit to the matching ARP and from the cash in the account at which cash is tracked (e.g., in a general ledger).

EOPDI system 30 also provides the functionality of allowing users to research accounts receivable by locating posted OPs. For example, EOPDI system 30 may present a GUI to the user allowing the user to select an ARP to research. EOPDI system 30 then may present a listing of OPs (e.g., showing amounts of the OPs) posted to the selected ARP. The user may select one or more posted OPs to view, and EOPDI system 30 may retrieve images of the selected OPs from OPARP database 40 or request those images from OP repository 80 using known techniques.

As shown above, the embodiments of the invention provide many advantages, including improving a user's ability to: (a) locate and identify the correct customer account receivable to which to post cash; (b) allocate and post funds received to one or more outstanding receivables; (c) create a bank deposit ticket; (d) generate a cash entry to the general ledger; (e) image checks for delivery and clearance through the banking system; and (f) store/retain, archive and index images of checks for future customer service, research or other important business purposes.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

What is claimed is:

1. A method for facilitating the operation of an electronic accounting system, comprising:
receiving data describing an obligation to pay;
comparing the received data with data stored in one or more records, wherein each of the one or more records stores data describing a previously received obligation to pay and one of one or more accounts requiring payment at an electronic accounting system to which the previously received obligation to pay was posted;
identifying each of the one or more records whose description of a previously received obligation to pay matches the received data;
receiving from a user a selection of one of the identified records; and
causing the electronic accounting system to post the obligation to pay described by the received data to the account requiring payment described in the selected record.

2. The method of claim 1, further comprising:
if there are no identified records
receiving from a user a selection of one of the one or more accounts requiring payment at the electronic accounting system;
adding a record to the one or more records, the added record storing the received data and data describing the selected account requiring payment; and
causing the electronic accounting system to post the obligation to pay described by the received data to the selected account requiring payment.

3. The method of claim 2, wherein the received data includes an amount to be paid;
wherein the electronic accounting system has an account in which cash is tracked; and
wherein the method further comprises causing the electronic accounting system to credit the amount described by the received data to the account in which cash is tracked.

4. The method of claim 3, wherein the account in which cash is tracked is part of a general ledger.

5. The method of claim 1, wherein the obligations to pay described by the received data and the data stored in each of the one or more records includes one or more checks.

6. The method of claim 1, wherein the obligations to pay described by the received data and the data stored in each of the one or more records includes one or more electronic funds transfers.

7. The method of claim 1, wherein the one or more accounts requiring payment includes one or more accounts receivable.

8. A method for facilitating the operation of an electronic accounting system having an account in which cash is tracked, comprising:
receiving data describing an obligation to pay being returned, including an amount;
identifying an account requiring payment at the electronic accounting system corresponding to the obligation to pay being returned; and
causing the electronic accounting system to subtract the amount of the obligation to pay being returned from the identified account requiring payment and from the account in which cash is tracked.

9. A method for facilitating the operation of an electronic accounting system having an account in which cash is tracked, comprising:
receiving data describing a plurality of obligations to pay, the data including an amount to be paid for each of the plurality of obligations to pay;
for each of the plurality of obligations to pay described by the received data, processing a portion of the received data describing the respective obligation to pay by:
comparing the portion of the received data describing the respective obligation to pay with data stored in one or more records, wherein each of the one or more records stores data describing a previously received obligation to pay and one of one or more accounts requiring payment at the electronic accounting system to which the previously received obligation to pay was posted;
identifying each of the one or more records whose description of a previously received obligation to pay matches the portion of the received data describing the respective obligation to pay;
receiving from a user a selection of one of the identified records;
causing the electronic accounting system to post the respective obligation to pay to the account requiring payment described in the selected record;
if there are no identified records
receiving from a user a selection of one of the one or more accounts requiring payment at the electronic accounting system;
adding a record to the one or more records, the added record storing the portion of the received data describing the respective obligation to pay and data describing the selected account requiring payment;
causing the electronic accounting system to post the respective obligation to pay to the selected account requiring payment;
accumulating the amount of the respective obligation to pay with the amount of any obligation to pay of the plurality of obligations to pay whose data has been previously processed; and
causing the electronic accounting system to credit the amount accumulated from all the obligations to pay of the plurality of obligations to pay to the account in which cash is tracked.

10. A system for facilitating the operation of an electronic accounting system comprising at least one computer programmed to:
receive data describing an obligation to pay;
compare the received data with data stored in one or more records, wherein each of the one or more records stores data describing a previously received obligation to pay and one of one or more accounts requiring payment at an electronic accounting system to which the previously received obligation to pay was posted;
identify each of the one or more records whose description of a previously received obligation to pay matches the received data;
receive from a user a selection of one of the identified records; and
cause the electronic accounting system to post the obligation to pay described by the received data to the account requiring payment described in the selected record.

11. A computer readable medium or media having programming stored thereon that when executed by at least one computer causes the at least one computer to:
receive data describing an obligation to pay;
compare the received data with data stored in one or more records, wherein each of the one or more records stores data describing a previously received obligation to pay and one of one or more accounts requiring payment at an electronic accounting system to which the previously received obligation to pay was posted;
identify each of the one or more records whose description of a previously received obligation to pay matches the received data;
receive from a user a selection of one of the identified records; and
cause the electronic accounting system to post the obligation to pay described by the received data to the account requiring payment described in the selected record.

12. A system for facilitating the operation of an electronic accounting system having an account in which cash is tracked, the system comprising at least one computer programmed to:
receive data describing an obligation to pay being returned, including an amount;
identify an account requiring payment at the electronic accounting system corresponding to the obligation to pay being returned; and
cause the electronic accounting system to subtract the amount of the obligation to pay being returned from the identified account requiring payment and from the account in which cash is tracked.

13. A computer readable medium or media having programming stored thereon that when executed by at least one computer causes the at least one computer to:
receive data describing an obligation to pay being returned, including an amount;
identify an account requiring payment at an electronic accounting system corresponding to the obligation to pay being returned, wherein the electronic accounting system has an account in which cash is tracked; and
cause the electronic accounting system to subtract the amount of the obligation to pay being returned from the identified account requiring payment and from the account in which cash is tracked.

14. A system for facilitating the operation of an electronic accounting system having an account in which cash is tracked, the system comprising at least one computer programmed to:
receive data describing a plurality of obligations to pay, the data including an amount to be paid for each of the plurality of obligations to pay;
for each of the plurality of obligations to pay described by the received data, process a portion of the received data describing the respective obligation to pay by:
comparing the portion of the received data describing the respective obligation to pay with data stored in one or more records, wherein each of the one or more records stores data describing a previously received obligation to pay and one of one or more accounts requiring payment at the electronic accounting system to which the previously received obligation to pay was posted;
identifying each of the one or more records whose description of a previously received obligation to pay matches the portion of the received data describing the respective obligation to pay;
receiving from a user a selection of one of the identified records;
causing the electronic accounting system to post the respective obligation to pay to the account requiring payment described in the selected record;
if there are no identified records
receiving from a user a selection of one of the one or more accounts requiring payment at the electronic accounting system;
adding a record to the one or more records, the added record storing the portion of the received data describing the respective obligation to pay and data describing the selected account requiring payment;
causing the electronic accounting system to post the respective obligation to pay to the selected account requiring payment;
accumulating the amount of the respective obligation to pay with the amount of any obligation to pay of the plurality of obligations to pay whose data has been previously processed; and
cause the electronic accounting system to credit the amount accumulated from all the obligations to pay of the plurality of obligations to pay to the account in which cash is tracked.

15. A computer readable medium or media having programming stored thereon that when executed by at least one computer causes the at least one computer to:
receive data describing a plurality of obligations to pay, the data including an amount to be paid for each of the plurality of obligations to pay;
for each of the plurality of obligations to pay described by the received data, process a portion of the received data describing the respective obligation to pay by:
comparing the portion of the received data describing the respective obligation to pay with data stored in one or more records, wherein each of the one or more records stores data describing a previously received obligation to pay and one of one or more accounts requiring payment at an electronic accounting system to which the previously received obligation to pay was posted, wherein the electronic accounting system has an account in which cash is tracked;
identifying each of the one or more records whose description of a previously received obligation to pay matches the portion of the received data describing the respective obligation to pay;
receiving from a user a selection of one of the identified records;
causing the electronic accounting system to post the respective obligation to pay to the account requiring payment described in the selected record;
if there are no identified records
receiving from a user a selection of one of the one or more accounts requiring payment at the electronic accounting system;
adding a record to the one or more records, the added record storing the portion of the received data describing the respective obligation to pay and data describing the selected account requiring payment;
causing the electronic accounting system to post the respective obligation to pay to the selected account requiring payment;
accumulating the amount of the respective obligation to pay with the amount of any obligation to pay of the plurality of obligations to pay whose data has been previously processed; and
cause the electronic accounting system to credit the amount accumulated from all the obligations to pay of the plurality of obligations to pay to the account in which cash is tracked
